(19) United States
(12) Patent Application Publication
(10) Pub. No.: US 2009/0327172 A1
(43) Pub. Date: Dec. 31, 2009

(54) ADAPTIVE KNOWLEDGE-BASED REASONING IN AUTONOMIC COMPUTING SYSTEMS

(75) Inventors: Yan Liu, Hanover Park, IL (US); Michael Zhihe Z. Jiang, Lake in the Hills, IL (US); John C. Strassner, North Barrington, IL (US); Jing Zhang, Schaumberg, IL (US)

Correspondence Address: FLEIT, GIBBONS, GUTMAN, BONGINI;& BIANCO P.L., 551 N.W. 77TH STREET, SUITE 111, BOCA RATON, FL, 33487, US

(73) Assignee: Motorola, Inc., Schaumburg, IL (US)

(21) Appl. No.: 12/163,295

(22) Filed: Jun. 27, 2008

(51) Int. Cl. G06F 15/18

(52) U.S. Cl. 706/12

(57) ABSTRACT

A method, information processing system, and network select machine learning algorithms for managing autonomous operations of network elements. A state (404) of at least one problem (406) and at least one context associated with the problem are received as input. A machine learning algorithm (118) is selected (410) based on the problem and context of the problem that have been received. The machine learning algorithm (118) that has been selected is outputted to an autonomic controller.

### FIELD OF THE INVENTION

The present invention generally relates to the field of autonomic computing, and more particularly relates to knowledge-based reasoning using reinforcement learning mechanisms.

### BACKGROUND OF THE INVENTION

Autonomic computing combines information modeling, data and knowledge transformation, and a control loop architecture to enable governance of telecommunications and data communications infrastructure. The key to autonomic computing lies in the advance of artificial intelligence technologies (See For example, Strassner, J., “Policy-Based Network Management”, Morgan Kaufman Publishers, September 2003, ISBN 1-55860-859-1 and Strassner, J., “Autonomic Networking—Theory and Practice”, IEEE Tutorial, December 2004”, where is hereby incorporated by reference in its entirety). Autonomic computing demands that the selection of machine learning and reasoning methods be automated both dynamically and adaptively.

Current autonomic computing systems generally do not offer any acceptable solutions for automating machine learning model/algorithm selection for autonomic computing. Most algorithm selection schemes use empirical validation techniques that are based on trial and error via offline examinations, which are inapplicable to autonomic computing systems. Others use reinforcement learning to tune performances of certain machine learning techniques. Although this application of reinforcement learning might succeed in improving one particular machine learning method, it still fails to provide a generic solution to selection automation in general for autonomic computing systems.

In general, the deficiencies of conventional autonomic systems fail to address the problem of learning algorithm/model selection and provide an effective solution to the problem. In other words, conventional autonomic systems do not provide dynamic and adaptive selection strategies as demanded by autonomous learning algorithm selection methods. These systems generally fail to base the selection of a machine learning algorithm/model over a classified problem on the context of the problem in lieu of the environmental conditions only. The systems do not take into with regards to decision making account a broader and complete spectrum of information that is covered by the context of the problem. Further, these systems fail to guide the reinforcement learning mechanism for algorithm selection by certain policies and further controlled by such policies.

Therefore a need exists to overcome the problems with the prior art as discussed above.

### SUMMARY OF THE INVENTION

In one embodiment, a method for selecting a machine learning algorithm is disclosed. The method comprises receiving as an input a state of at least one problem and at least one context associated with the problem. A machine learning algorithm is selected based on the problem and context of the problem that have been received. The machine learning algorithm that has been selected is outputted to an autonomic controller.

In another embodiment, an information processing system for selecting a machine learning algorithm is disclosed. The information processing system comprises a memory and a processor that is communicatively coupled to the memory. The information processing system further includes an autonomic manager that is communicatively coupled to the memory and the processor. The autonomic manager is adapted to receive as an input a state of at least one problem and at least one context associated with the problem. A machine learning algorithm is selected based on the problem and context of the problem that have been received. The machine learning algorithm that has been selected is outputted to an autonomic controller.

In yet another embodiment, a network for managing autonomous operations of networking elements is disclosed. The network comprises a first network element and at least a second network element. The network also includes at least one information processing system that is communicatively coupled to the first network element and the at least second network element. The at least one information processing system comprising a memory and a processor that is communicatively coupled to the memory. The information processing system further includes an autonomic manager that is communicatively coupled to the memory and the processor. The autonomic manager is adapted to receive as an input a state of at least one problem and at least one context associated with the problem. A machine learning algorithm is selected based on the problem and context of the problem that have been received. The machine learning algorithm that has been selected is outputted to an autonomic controller.

The various embodiments of the present invention are advantageous because they address the need for autonomous selection of one or more machine learning algorithms within the aegis of autonomic computing. For example, the various embodiments determine the optimal or near-optimal processing technique(s) and algorithm(s) to use for a given problem using reinforcement learning. This enables the autonomic computing system to adaptively, dynamically, and autonomously make decisions as to which reasoning and learning algorithm(s) and method(s) to employ after problem classification. Stated differently, this reinforcement learning based dynamic mechanism allows the system to adaptively learn and reason about the machine learning selection process for a classified problem and thus optimize the learning performance to solve the problem. Therefore, the possibility space is delimited such that exhaustive combinatorial exploration for algorithm selection and performance optimization is not required. The reinforcement learning of the various embodiment also enable a policy directed learning strategy selection and supports policy derivation for dynamic learning control, adding further precision to the manifested policy governed control mechanism.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a general overview of an operating environment according to one embodiment of the present invention;

FIG. 2 illustrates a simplified Unified Modeling Language (“UML”) model of a machine learning selector according to one embodiment of the present invention;

FIG. 3 is block diagram that models the context-based reinforcement learning process of the machine learning selector according to one embodiment of the present invention

FIG. 4 is an operational flow diagram illustrating a process of context-based reinforcement learning according to one embodiment of the present invention; and

FIG. 5 is a block diagram illustrating a detailed view of an information processing system, according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

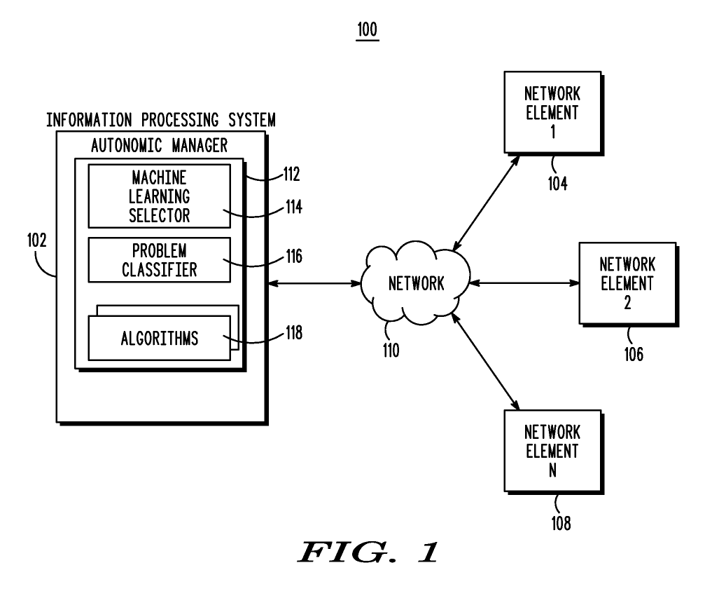

General Operating Environment According to one embodiment of the present invention as shown in FIG. 1 a general overview of an operating environment 100 is illustrated. In particular, the operating environment 100 includes one or more information processing systems 102 communicatively coupled to one or more network elements/managed entitles 104, 106, 108. A network element/managed entity, in one embodiment, can be (but not limited to) routers, switches, hubs, gateways, base stations, servers, client nodes, and wireless communication devices. These network elements can also be referred to as resources as well. It should be noted that a managed entity can also be a service or non-hardware resources such as (but not limited to) memory and applications. The information processing system 102 is communicatively coupled to each of the network elements 104, 106, 108 via one or more networks 110, which can comprise wired and/or wireless technologies.

The information processing system, in one embodiment, includes an autonomic manager 112, which comprises a machine learning selector 114, a problem classifier 116, and one or more reasoning and learning algorithms 118. It should be noted that although the machine learning selector 114, problem classifier 116, and one or more algorithms 118 are shown residing within the autonomic manager 112, one or more of these components can reside outside of the autonomic manager 112 as well.

The autonomic manager 112, in one embodiment, utilizes a model-integrated, state-based control mechanism that orchestrates autonomous operations of the networking elements 104, 106, 108. Autonomic Architectures applicable to the various embodiments of the present invention are discussed in greater detail in the following U.S. patent application Ser. No. 11/422,681, filed on Jun. 7, 2006 entitled “Method and Apparatus for Realizing an Autonomic Computing Architecture Using Knowledge Engineering Mechanisms”, with Attorney Docket Number CML03322N and U.S. patent application Ser. No. 11/618,125, filed on Dec. 29, 2006, entitled, “Method and apparatus to use graph-theoretic techniques to analyze and optimize policy deployment”, with Attorney Docket Number CML04644MNG, which are both incorporated by reference in the entireties. Also, autonomic control of network elements is further discussed in U.S. patent application Ser. No. 12/124,560, filed on May 21, 2008, entitled “Autonomous Operation of Networking Devices”, with Attorney Docket Number CML06665 which is hereby incorporated by reference in its entirety.

In one embodiment, autonomous operations of the networking elements 104, 106, 108 are facilitated by the autonomic manager 112 using the machine learning selector 114. The machine learning selector 114, in one embodiment, utilizes a reinforcement learning based dynamic approach for selecting appropriate reasoning and learning algorithms after a problem classification process has been performed. In addition to the following discussion, U.S. patent application Ser. No. 11/422,671 filed on Jun. 7, 2006, entitled “Method and Apparatus for Controlling Autonomic Computing System Processes Using Knowledge-Based Reasoning Mechanisms”, CML03124N, also discusses the machine learning selector 114 in detail, and is hereby incorporated by reference in its entirety.

Machine Learning Selector

The following is a detailed discussion of the machine learning selector 114; the process of utilizing reinforcement learning by as an adaptive learning model to dynamically explore and select between a plurality of machine learning approaches and fine tune their performances; and the definition and modeling of the relationship between the machine learning selector 114 and other entities that are related to the selector 114.

The following discussion with respect to the machine learning selector 114 begins after a problem has been classified such that no abductive algorithm can be applied to solve the problem and the control has been thus passed onto the machine learning selector 114 to select from a plurality of machine learning algorithms to “characterize and learn more about the current problem”. Once control has been passed to the machine learning selector 114, the selector 114 closely examines the problem and selects the most suitable algorithm(s) and optimal or near-optimal parameters for the algorithm(s) to learn and reason about the problem. The selection itself hence becomes a learning and optimization problem that should also be governed and controlled by policy.

When a match between a specific problem and a particular algorithm is found using knowledge obtained from one or more sources, such as ontology models and/or information models, a policy-controlled algorithm selection in this case is straightforward and can be invoked and accomplished through a sequence of pre-defined learning activities. In the absence of a unique match, or further when an optimal or near optimal algorithmic performance is required based on parameterization and learning rule selection, additional knowledge and guidance needs to be supplied to the selector 114 in order to make further decisions on optimizing the selection and refining the selected learning algorithm. Such decisions require further exploration of the classified problem and the context of the problem as well as the managed resource that are associated with the observed problem.

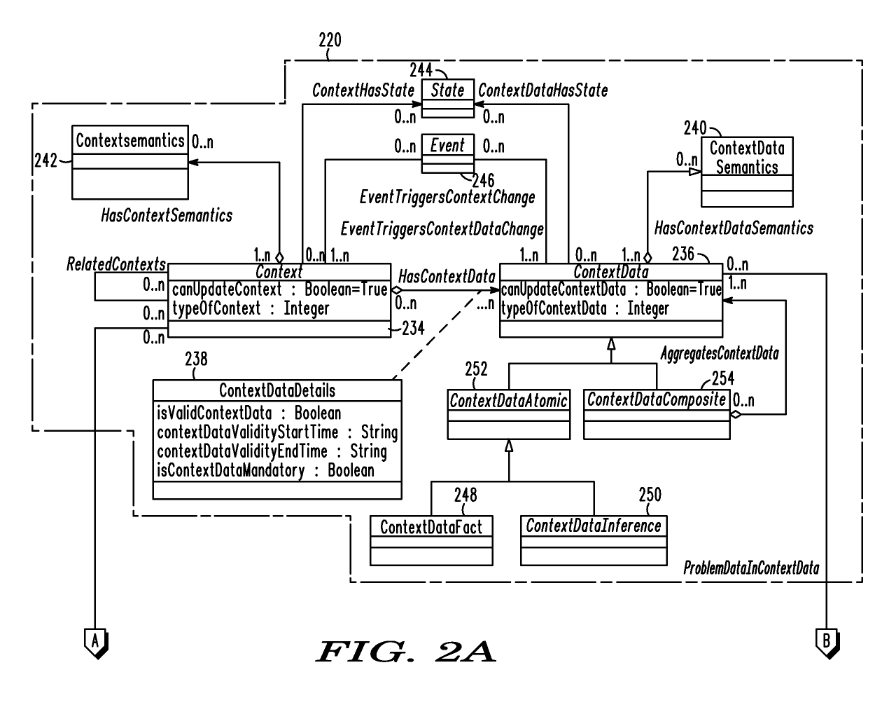

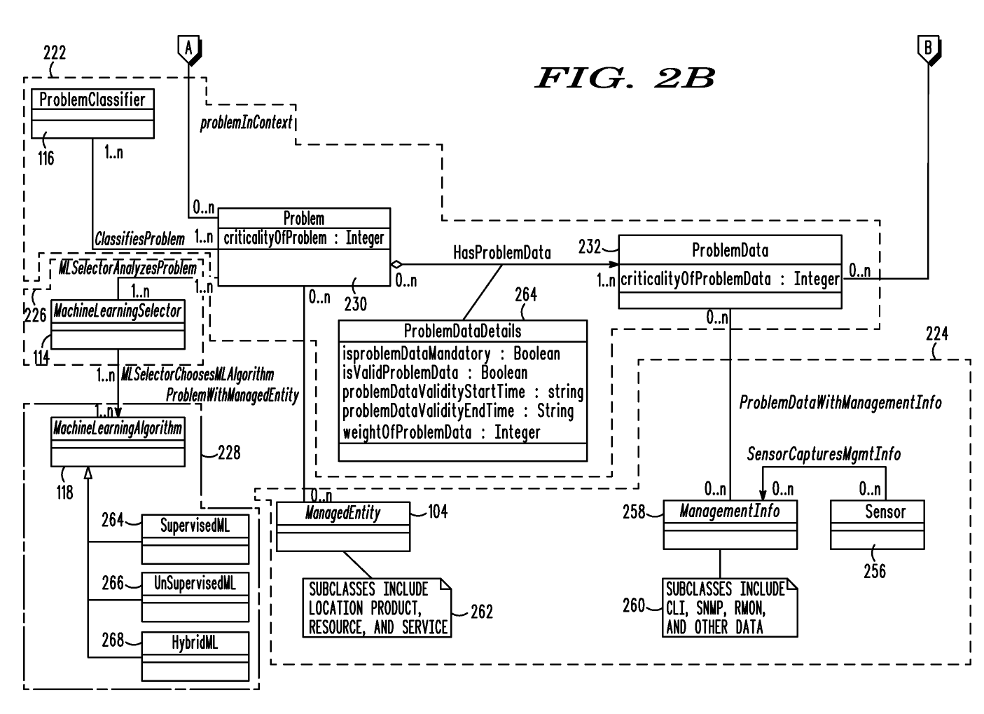

FIG. 2 illustrates a simplified Unified Modeling Language (“UML”) model of the machine learning selector 114 and its relationship with other related entities in the context of autonomic computing models. In this simplified model, the relationships between five important entities that, in one embodiment, are the core components to the reinforcement learning based machine learning selector 114 are captured. These five entities are reflected in the connect section 220, the problem section 222, the managed resource section 224, the machine learning selector section 226, and the algorithm section 228 of the model illustrated in FIG. 2.

Throughout this discussion, “context” of an entity is defined as the set of all activities and their associated context information for a given entity. The term “context information” is defined as the set of facts (either directly provable or inferred) associated with an activity, whose probability is above the minimum or below the maximum threshold of that activity. Given the above two definitions, for the purposes of this discussion, context covers all information that is directly or indirectly relevant to the observed managed object(s) (e.g. network elements/managed entities 104). Relevancy is not necessarily a simple “yes or no”; for example, a given fact could have a probability of being relevant for different contexts. In one embodiment, the DEN-ng context model is used for modeling contact. An overview of this model is shown in “Design of a New Context-Aware Policy Model for Autonomic Networking” by Strassner et. al, accepted for publication in Proc. of International Conference on Autonomic Computing (ICAC'08), a copy of which is provided as part of an information disclosure statement and which is hereby incorporated by reference in its entirety.

The context section 200 of the model shown in FIG. 2, in one embodiment, is used to narrow the focus of the problem and problem data mechanisms. Stated differently, the context section 220 focuses acquisition on information to build up the problem 230 and problem data 232 mechanisms. Context comprises two levels of filtering, the first level filters or selects paths that are only relevant to a particular context, and the second level identifies things of interest so that a set of policies can be applied to govern the behavior of the system.

As shown in FIG. 2, a context 234 is made up of one or more sets of ContextData 236 having various ContextDataDetails 238. This enables each type of context 236 to be represented by a plurality of facts and knowledge, which enables each type of context 236 to be more easily and flexibly described. For example, this approach enables the semantics 240 of the individual ContextData elements 236 to be modeled separately from the semantics 242 of the aggregated Context 234. This is important, as often the aggregate exhibits different behavior than each of its individual components. Also, the state 244 of the context 234 and context data 236 is monitored as well as any events 246 related to the context 234 and context data 236, as is discussed further below. An event 246 can trigger a context change and/or a context data change.

The context data information sets 236 are captured by sensors that gather information from different sources, which include the environment the system is currently operating in, the events reported by the resources as a result of interaction between system and environment, and the system in which the object resides. Note that this is complicated by the required use of multiple sensors, which in general can each have different data formats and use different data structures.

Using the data gathering process discussed in U.S. patent application Ser. No. 11/422,642, filed on Jun. 7, 2006, entitled “Harmonizing the Gathering of Data and Issuing of Commands in an Autonomic Computing System Using Model-Based Translation”, with Attorney Docket Number CML02997MNG, which is hereby incorporated by reference in its entirety. Each sensor captures relevant information (as directed by one or more policies); this is then fed into a model-based translation layer, which translates the sensor data into a single, normalized format. This translated data is then used to populate appropriate context data 236.

As can be seen in FIG. 2, relevant information sets such as ContextDataFact 248, ContextDataInference 250, ContextDataAtomic 252, and ContextDataComposite 254 are aggregated in a context data 236. The context data 236 is then tagged with semantics 240 that can then be mapped to and associated with the identified problem(s) which have been classified by the problem classifier 256 as defined in the above cited U.S. patent application Ser. No. 11/422,671, filed on Jun. 7, 2006, “Methods and Apparatus for Problem Classification in Autonomic Computing Systems Using Knowledge-Based Reasoning”.

Different types of managed entities 104 (e.g., services and resources) can each have one or more problems 230. As shown in FIG. 2 various sensors 256 capture management information 258 associated with each managed entity 104. The captured management information 258 represents the binding of that sensor 256 to the managed entity 104 and the delivery of the captured information 259 that describes the actual problem. Management information 258 can include subclasses 260 of information such as CLI, SNMP, RMON, and other data. Managed entities 104 can include subclasses 262 such as location, product, resources, and service.

It should be noted that the cardinality of the relationship ProblemWithManagedEntity between the Problem 230 class and the ManagedEntity class 104 is 0 . . . n on both sides to indicate that the managed entity 104 can have no problems or multiple problems. If a problem does exits, that problem consists of a set of problem data based on information captured by the sensor. It should also be noted that a problem will have problem data, but problem data does not have to be associated with a problem. This allows the system to accumulate problem data without actually jumping to conclusions that a problem does in fact exist.

Each problem 230 is made up of one or more types of data 232 (ProblemData) that together define the nature and extent of the problem 230. Each problem data 232 is associated with certain management info that is captured by one or more sensors. Each problem data 232 is also associated with a context, as shown by the ProblemDataInContextData relationship. Each problem data 232 gets aggregated into a problem 230 and is classified by the problem classifier 116 based on the characteristics of the problem. The problem classification follows the method and process as defined in the above cited U.S. patent application Ser. No. 11/422,671 entitled X “Methods and Apparatus for Problem Classification in Autonomic Computing Systems Using Knowledge-Based Reasoning”.

The context 234 of a problem can be defined as all information that is relevant to the problem 234. This notion of relevancy comes from two different domains, i.e. 1) the contextual information of the problem itself, as shown be the relationship ProblemInContext, in the evolving space of problems, and 2) the contextual information of the object(s) that are directly linked to the problem, as shown by the relationship ProblemDataInContextData.

For example, a link-down problem would be associated with the context of the resources at both ends of the link and the link object itself. Hence, the relationships can be further specified as follows. Let P denote the problem domain and O denote the object domain. Moreover, let Cp denote the context of problem p and Co denote the context of an object. Assume that for every problem p, there exists a set of object(s), denoted by Op, which is classified as p-relevant. Then intuitively, the context of p in domain O, denoted by Cp-o, is a subset of the union of the context of every individual o that belongs to Op.

$${C}_{p - o} ⊆ {⋃}_{o ∈ {O}_{p}} {C}_{o} \qquad ( Eq . 1 )$$

Now the context of p in domain P is denoted as Cp-p, whereby the context of p, Cp, is obtained, which is composed of Cp-p and Cp-o, as follows.

C_{p⊂C}ₚ₋ₚ∪Cₚ₋ₒ (Eq. 2)

The context of p, Cp, is perceived and identified as one of the states in a discrete set of context states, representing the states of the world where the problem was identified and classified.

Once a problem 230 has been classified, the machine learning selector 114 selects 114 suitable algorithm(s) 118 to learn and reason about the classified problem. The decision is made through reinforcement learning as is further discussed below. In general, after being classified and analyzed, a problem 230 is now associated with a limited number of learning algorithms 118 (FIG. 2 shows a generalization of a supervised machine learning algorithm 264, an unsupervised machine learning algorithm 266, and a hybrid machine learning algorithm 268) and models that are considered suitable for the problem.

This association can be a result of direct matching or based on certain policies. In many cases, this association can be a one-to-many relationship between the problem 230 and the subset of algorithms 118 that are regarded as suitable for solving this problem. This is due to the existence of a variety of machine learning algorithms (See, for example, Mitchell, T., “Machine Learning”, McGraw-Hill International Editions, 1197, ISBN 0-07-042807-7, which is hereby incorporated by reference in its entirety), each of which can be used to learn more about various types of problems. Their application depends upon not only the problem that trying to be solved, but also on the data that are associated with the problem 230.

The one-to-many relationship exists commonly in instance-based machine learning domains due to the popularity and increasing attention of such algorithms (See, for example, Mitchell, T., “Machine Learning”, McGraw-Hill International Editions, 1197, ISBN 0-07-042807-7”, where is hereby incorporated by reference in its entirety.) Instance-based learning algorithms are usually derived from optimization theory or mathematical approximation models, aiming to reaching a certain convergence performance in its learning with a proven mathematical algorithm. Based on their learning patterns, the learning can be categorized into supervised learning, unsupervised learning, or a hybrid of both. Supervised learning, mainly for the purpose of classification, learns from existing examples with a defined input output pattern, while unsupervised learning, commonly used in clustering, examines and characterizes the data and discovers hidden patterns exhibited by the learning examples. Most of these learning models, such as neural networks, k nearest-neighbor, association rule learning, support vector machines, and others, are parameterized and their performance is fine-tuned through empirical validation.

Although the power of many machine learning algorithms has been demonstrated by their successful applications, these learning algorithms can neither be intelligently selected nor have their performance be easily optimized by a single policy. This is because problems by their nature vary over different operational domains and evolve over time. This process of selection and optimization itself needs learning from its experience and exploration, which makes an intuitive adaptive learning paradigm highly desirable for such a selection and optimization process.

Therefore, the machine learning selector 114 of the various embodiments of the present invention utilizes a reinforcement learning process. The following is a more detailed discussion on that reinforcement learning process. Reinforcement learning is an intuitive form of learning that is well suited for unsupervised learning situations (See, for example, Sutton, R. S. and Barto, A. G. 1998 “Introduction to Reinforcement Learning”. 1st. MIT Press, which is hereby incorporated by reference in its entirety). Closely related to adaptive control, reinforcement learning has the following principles. If an action taken by a learner such as the machine learning selector 114 results in a satisfactory state, this particular action is rewarded or reinforced to increase the likelihood this action to be taken should the same situation presents again. A learner (i.e., an agent) is connected to the environment and gathers all relevant data from the environment.

By translating the environmental data into states (such as the states 244 shown in FIG. 2) and converting them into inputs, the agent then takes an action and generates some output, which is also converted to certain environmental state. The agent then receives a reinforcement signal, usually in the form of a scalar value, from the state changes of the environment. The ultimate goal of an agent is to maximize the reward it receives for its action. However, this goal might be set in slightly different forms as some approaches would consider long term effect of the actions versus others would prefer short term effects.

When using reinforcement learning for machine learning selection, the decision would be biased if the environmental state transformation was solely relied on to compute the reinforcement for a selection (e.g., selection of a machine learning algorithm). This is because the impact of the actions might not be instant and direct as that of simple and physical actions. Environmental states do not provide sufficient information for an adequate decision. Rather, the reward is determined by a broader collection of data, the context data 236 that represent all relevant information and knowledge of the problem 230.

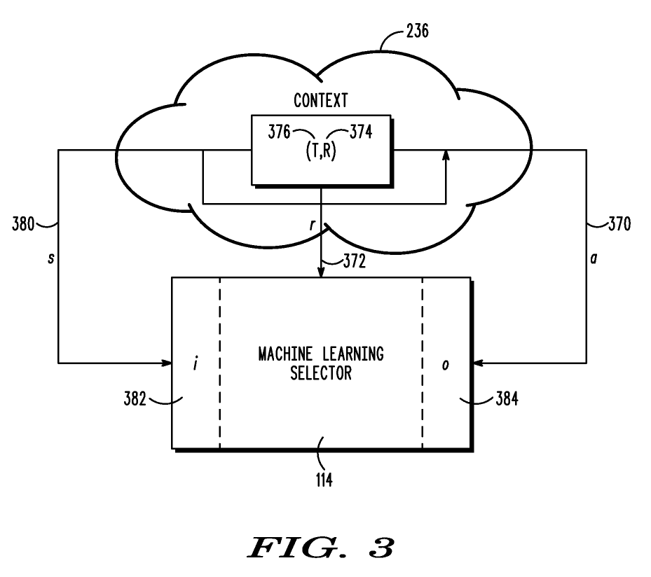

FIG. 3 is a block diagram modeling the context-based reinforcement learning process of the machine learning selector 114. The reinforcement learning model of FIG. 3 includes context data c 236; possible actions a 370; and reinforcement in the form of a reward 372, denoted by r, computed by a reward function R 374. R defines the goal of the reinforcement learning by mapping every (context, action) pair to a particular reward value. In general, the reward function 374 is specified by goal-type policies that tune the reward 372 in response to the actions 370. FIG. 3 also includes a state transition function T 376 for the problem 230 that maps (context 236, action 370) pairs to probability distributions over the context state space S an input i 382 (identified problem); and an output o 384 (selected learning algorithm/model).

Once goal of the machine learning selector 114 is to find a mapping between the (context, problem) tuple and the machine learning algorithms that will perform the learning tasks to characterize, classify, and optimally or near-optimally (in terms of performance and robustness) reason about the problem. This optimality is ranked and specified by high level policies and takes effect in the form of the reward function.

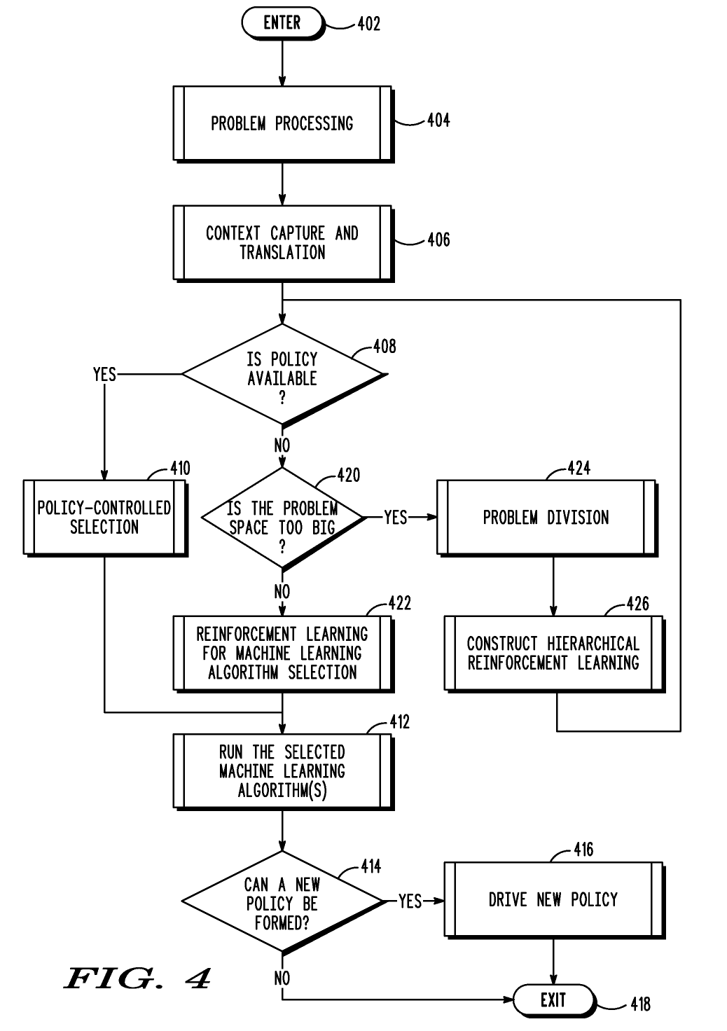

FIG. 4 shows the context-based reinforcement learning process of the machine learning selector 114 as modeled in FIG. 3 in more detail. In particular, FIG. 4 is an operational flow diagram illustrating the process of context-based reinforcement learning with respect to the machine learning selector 114. The process of FIG. 4 beings after the process of problem acquisition and classification, which has been discussed above and in is covered by the activities presented in the above cited U.S. patent application Ser. No. 11/465,860 entitled “Method and Apparatus for Controlling Autonomic Computing System Processes Using Knowledge-Based Reasoning Mechanisms”, with attorney docket No. CML03003N, which is hereby incorporated by reference in its entirety. The various embodiments of the present invention take the output of the problem acquisition and classification process and submit it to the reinforcement learning based selector 114.

In one embodiment, the learning selection takes the same steps as described in FIG. 3 of the above cited U.S. patent application Ser. No. 11/465,860 entitled “Method and Apparatus for Controlling Autonomic Computing System Processes Using Knowledge-Based Reasoning Mechanisms, in order to complete the dynamic algorithm selection as well as model parameterization. All steps, in one embodiment, are defined based on the same notation of policy-controlled autonomic selection as defined U.S. patent application Serial No. U.S. patent application Ser. No. 11/618,125, filed on Dec. 29, 2006, entitled, “Method and apparatus to use graph-theoretic techniques to analyze and optimize policy deployment”, with Attorney Docket Number CML04644MNG, which is hereby incorporated in its entirety.

The operational flow diagram of FIG. 4 begins at step 402 and flows directly to step 404. Once a problem has been classified, the machine learning selector 114, at step 404, begins the processing the problem 230. The machine learning selector 114, at step 406, then performs context capture and translation. For example, context data 236 needs to be collected and translated into a common form, so that objects instantiated from the context model can be populated with the sensed data (corresponding to the Context 234 and ContextData 236 classes in FIG. 2). Then, these data sets are used as nodes and transitions in one or more Finite State Machine (“FSM”) diagrams, which are used to orchestrate behavior. FSMs for orchestrating behavior as discussed in more detail in the above cited U.S. patent application Ser. No. 12/124,560, filed on May 21, 2008, entitled “Autonomous Operation of Networking Devices”,

Once the relevant information and knowledge are translated and described using FSMs, the machine learning selector 114, at step 408, queries an existing policy base to determine if there is a match between the (context 234, problem 230) pair and one or more policies. This matching process uses the embedded semantic information of the individual parts of the context 234 (i.e., ContextDataSemantics 240) as well as the overall context (i.e., ContextSemantics 242) itself, as shown in FIG. 2. If a match does exist, the machine learning selector 114 determines if the modeled context associated with the problem is not semantically complete. If the modeled context is not complete, then additional knowledge is gathered to attempt to supply the lacking semantics. Given as complete a set of semantics as possible and a match found, policy controlled selection, at step 410, is invoked to execute the algorithm for problem reasoning and/or resolution at step 412.

If a policy matching cannot be found and the machine learning selector determines, at step 420 that the problem space is not too big, then an exploration of certain types of algorithms is needed. This is done through reinforcement learning. From this point on, the machine learning selector 114, at step 422, adopts reinforcement learning to dynamically adjust its algorithm selection strategy. A mapping is formed between the tuple (context 234, problem 230) and the corresponding machine learning algorithm 118 and its parameters. The machine learning algorithm, at step 412, runs the selected machine learning algorithm. If the problem state space becomes large, the problem 230, at step 424, is divided and a hierarchical set of learning sub-problems and reinforcement learning, at step 426, is applied to each of the sub-problems. The control flow then returns to step 408.

After a certain period of learning, when convergence is reached, an optimal or near-optimal performance algorithm selection is then stabilized. The machine learning selector 114, at step 414, then determines if one or more policies can be derived from the (context, problem) pair and its corresponding optimal or near-optimal machine learning algorithm. If a new policy cannot be formed, the control flow exits at step 418. If new policy can be formed, the machine learning selector 114, at step 416, derives a new policy.

This newly derived policy or set of policies can thus be incorporated into the policy base and be used when similar situations occur. Also, the computational complexity of the reinforcement learning algorithm can be fine-tuned and controlled by policy. This particular type of policy may be used to control the overall operation of the adaptive learning, including the formulation of its learning policy (e.g., delayed reward and immediate reward) and value function.

As can be seen from the above discussion the various embodiments of the present invention address the need for autonomous selection of one or more machine learning algorithms within the aegis of autonomic computing by implementing reinforcement learning. This enables the autonomic computing system to adaptively, dynamically, and autonomously make decisions as to which reasoning and learning algorithm(s) and method(s) to employ after problem classification.

Information Processing System

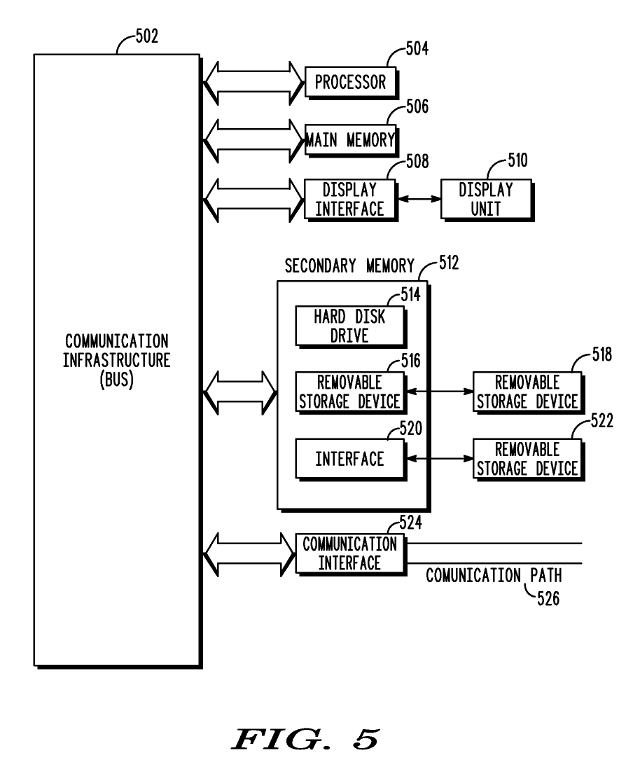

FIG. 5 is a high level block diagram illustrating a more detailed view of a computing system 500 such as the information processing system 102 useful for implementing the autonomic manager 112 and machine learning selector 114 according to embodiments of the present invention. The computing system 500 is based upon a suitably configured processing system adapted to implement an exemplary embodiment of the present invention. For example, a personal computer, workstation, or the like, may be used.

In one embodiment of the present invention, the computing system 500 includes one or more processors, such as processor 504. The processor 504 is connected to a communication infrastructure 502 (e.g., a communications bus, crossover bar, or network). Various software embodiments are described in terms of this exemplary computer system. After reading this description, it becomes apparent to a person of ordinary skill in the relevant art(s) how to implement the invention using other computer systems and/or computer architectures.

The computing system 500 can include a display interface 508 that forwards graphics, text, and other data from the communication infrastructure 502 (or from a frame buffer) for display on the display unit 510. The computing system 500 also includes a main memory 506, preferably random access memory (RAM), and may also include a secondary memory 512 as well as various caches and auxiliary memory as are normally found in computer systems. The secondary memory 512 may include, for example, a hard disk drive 514 and/or a removable storage drive 516, representing a floppy disk drive, a magnetic tape drive, an optical disk drive, and the like. The removable storage drive 516 reads from and/or writes to a removable storage unit 518 in a manner well known to those having ordinary skill in the art.

Removable storage unit 518, represents a floppy disk, a compact disc, magnetic tape, optical disk, etc. which is read by and written to by removable storage drive 516. As are appreciated, the removable storage unit 518 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer-readable information.

In alternative embodiments, the secondary memory 512 may include other similar means for allowing computer programs or other instructions to be loaded into the computing system 500. Such means may include, for example, a removable storage unit 522 and an interface 520. Examples of such may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to the computing system 500.

The computing system 500, in this example, includes a communications interface 524 that acts as an input and output and allows software and data to be transferred between the computing system 500 and external devices or access points via a communications path 526. Examples of communications interface 524 may include a modem, a network interface (such as an Ethernet card), a communications port, a PCMCIA slot and card, etc. Software and data transferred via communications interface 524 are in the form of signals which may be, for example, electronic, electromagnetic, optical, or other signals capable of being received by communications interface 524. The signals are provided to communications interface 524 via a communications path (i.e., channel) 526. The channel 526 carries signals and may be implemented using wire or cable, fiber optics, a phone line, a cellular phone link, an RF link, and/or other communications channels.

In this document, the terms “computer program medium,” “computer usable medium,” “computer readable medium”, “computer readable storage product”, and “computer program storage product” are used to generally refer to media such as main memory 506 and secondary memory 512, removable storage drive 516, and a hard disk installed in hard disk drive 514. The computer program products are means for providing software to the computer system. The computer readable medium allows the computer system to read data, instructions, messages or message packets, and other computer readable information from the computer readable medium.

Computer programs (also called computer control logic) are stored in main memory 506 and/or secondary memory 512. Computer programs may also be received via communications interface 524. Such computer programs, when executed, enable the computer system to perform the features of the various embodiments of the present invention as discussed herein. In particular, the computer programs, when executed, enable the processor 504 to perform the features of the computer system.

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for selection of a machine learning algorithm, the method comprising:
receiving as an input a state of at least one problem and at least one context associated with the problem;
selecting a machine learning algorithm based on the problem and context of the problem that have been received; and
outputting the machine learning algorithm that has been selected to an autonomic controller.

2. The method of claim 1, wherein selecting a machine learning algorithm, further comprises:
performing reinforcement learning with respect to selecting a machine learning algorithm, wherein the reinforcement learning dynamically adjusts a machine learning algorithm selection strategy used to select a machine learning algorithm.

3. The method of claim 2, wherein performing reinforcement learning, further comprises:
performing a selection at least one machine learning algorithm;
determining if the at least one machine learning algorithm results in a satisfactory state with respect to the problem; and
awarding a reinforcement value to the selection of the at least machine learning algorithm in response to the selection resulting in a satisfactory state with respect to the problem, wherein the reinforcement value increases a likelihood that the at least one machine learning algorithm is to be selected again with respect to a substantially similar problem.

4. The method of claim 1, wherein receiving as an input a state of at least one problem and at least one context associated with the problem, further comprises:
receiving a plurality of problem data information sets associate with at least one managed entity;
aggregating at least two problem data information sets in the plurality of problem data information sets; and
creating the problem based on the at least two problem data information sets that have been aggregated.

5. The method of claim 4, wherein aggregating at least two problem data information sets further comprises:
determining a relationship between the at least two problem data information sets and a context associated with each of the at least two problem data information sets.

6. The method of claim 1, further comprising:
receiving a set of policies as another input filtering the context based on at least one policy in the set of policies; and
selecting the machine learning algorithm based on the problem and the context that has been filtered.

7. The method of claim 1, wherein selecting a machine learning algorithm, further comprises:
selecting a group of machine learning algorithms; and
selecting a machine learning algorithm from within the group.

8. The method of claim 1, wherein the machine learning algorithm is one of:
a supervised machine learning algorithm;
an unsupervised machine learning algorithm; and
a hybrid machine learning algorithm comprising a combination of both the supervised machine learning algorithm and the unsupervised machine learning algorithm.

9. The method of claim 1, further comprising:
deriving, based on selecting the machine learning algorithm, at least one policy for governing a future selection of machine learning algorithms.

10. An information processing system for selecting a machine learning algorithm, the information processing system comprising:
a memory;
a processor communicatively coupled to the memory; and
an autonomic manager communicatively coupled to the memory and the processor, wherein the autonomic manager is adapted to;
receive as an input a state of at least one problem and at least one context associated with the problem;
select a machine learning algorithm based on the problem and context of the problem that have been received; and
output the machine learning algorithm that has been selected to an autonomic controller.

11. The information processing system of claim 10, wherein the autonomic manager is further adapted to select a machine learning algorithm by:
performing reinforcement learning with respect to selecting a machine learning algorithm, wherein the reinforcement learning dynamically adjusts a machine learning algorithm selection strategy used to select a machine learning algorithm.

12. The information processing system of claim 11, wherein performing reinforcement learning, further comprises:
performing a selection at least one machine learning algorithm;
determining if the at least one machine learning algorithm results in a satisfactory state with respect to the problem; and
awarding a reinforcement value to the selection of the at least machine learning algorithm in response to the selection resulting in a satisfactory state with respect to the problem, wherein the reinforcement value increases a likelihood that the at least one machine learning algorithm is to be selected again with respect to a substantially similar problem.

13. The information processing system of claim of claim 10, wherein the autonomic manager is further adapted to receive as an input a state of at least one problem and at least one context associated with the problem by:
receiving a plurality of problem data information sets associate with at least one managed entity;
aggregating at least two problem data information sets in the plurality of problem data information sets; and
creating the problem based on the at least two problem data information sets that have been aggregated.

14. The information processing system of claim of claim 10, wherein the autonomic manager is further adapted to:
receive a set of policies as another input filter the context based on at least one policy in the set of policies; and
select the machine learning algorithm based on the problem and the context that has been filtered.

15. The information processing system of claim of claim 10, wherein the autonomic manager is further adapted to:
deriving, based on selecting the machine learning algorithm, at least one policy for governing a future selection of machine learning algorithms.

16. A network for managing autonomous operations of networking elements the network comprising:
a first network element;
at least a second network element; and
at least one information processing system communicatively coupled to the first network element and the at least second network element, the at least one information processing system comprising:
a memory;
a processor communicatively coupled to the memory; and
an autonomic manager communicatively coupled to the memory and the processor, wherein the autonomic manager is adapted to;
receive as an input a state of at least one problem and at least one context associated with the problem, wherein the at least one problem and the context are further associated with at least one of the first network element and the at least second network element;
select a machine learning algorithm based on the problem and context of the problem that have been received; and
output the machine learning algorithm that has been selected to an autonomic controller.

17. The network of claim 16, wherein the autonomic manager is further adapted to select a machine learning algorithm by:
performing reinforcement learning with respect to selecting a machine learning algorithm, wherein the reinforcement learning dynamically adjusts a machine learning algorithm selection strategy used to select a machine learning algorithm; and
wherein performing reinforcement learning, further comprises:
performing a selection at least one machine learning algorithm;
determining if the at least one machine learning algorithm results in a satisfactory state with respect to the problem; and
awarding a reinforcement value to the selection of the at least machine learning algorithm in response to the selection resulting in a satisfactory state with respect to the problem, wherein the reinforcement value increases a likelihood that the at least one machine learning algorithm is to be selected again with respect to a substantially similar problem.

18. The network of claim of claim 16, wherein the autonomic manager is further adapted to receive as an input a state of at least one problem and at least one context associated with the problem by:
receiving a plurality of problem data information sets associate with at least one managed entity;
aggregating at least two problem data information sets in the plurality of problem data information sets; and
creating the problem based on the at least two problem data information sets that have been aggregated.

19. The network of claim of claim 16, wherein the autonomic manager is further adapted to:
receive a set of policies as another input
filter the context based on at least one policy in the set of policies; and
select the machine learning algorithm based on the problem and the context that has been filtered.

20. The network of claim of claim 16, wherein the autonomic manager is further adapted to:
deriving, based on selecting the machine learning algorithm, at least one policy for governing a future selection of machine learning algorithms.
